(19) United States
(12) Patent Application Publication
(10) Pub. No.: US 2016/0048891 A1
(43) Pub. Date: Feb. 18, 2016

(54) MISERY INDEX FOR A COMMUNITY

(71) Applicant: CLICK2CARE, INC ., La Jolla, CA (US)

(72) Inventors: Thomas C. Broadhead, San Diego, CA (US); Clifford T. Boro, San Diego, CA (US); Neil R. Senturia, La Jolla, CA (US); James R. Andreoni, San Diego, CA (US)

(21) Appl. No.: 14/826,101

(22) Filed: Aug. 13, 2015

Related U.S. Application Data
(60) Provisional application No. 62/037,525, filed on Aug. 14, 2014.
(60) Provisional application No. 62/109,536, filed on Jan. 29, 2015.

(51) Int. Cl. G06Q 30/02; G06Q 20/10

(52) U.S. Cl. CPC G06Q 30/0279; G06Q 20/10

(57) ABSTRACT

Described are platforms, systems, and media for expressing negative sentiment toward media reflecting an adverse impact on a particular community. The sentiments are expressed via push notifications sent to devices of friends within the community. Also described are platforms, systems, and media for a mobile micro impulse philanthropic application. The application enables a donor to have their online media analyzed and associated with various causes. This allows the donor to donate to the cause without having to research what charity or organization might support what they wish to donate to.

### CROSS-REFERENCE TO RELATED APPLICATIONS

This application claims the benefit of U.S. Patent Application No. 62/037,525, filed Aug. 14, 2014, and U.S. Patent Application No. 62/109,536, filed Jan. 29, 2015, the entire disclosures of which are hereby incorporated herein by reference.

### BACKGROUND OF THE INVENTION

A community is a social unit of any size that shares common values. Although embodied or face-to-face communities are usually small, larger or more extended communities such as national communities, international communities, and virtual communities also exist. In human communities, intent, belief, resources, preferences, needs, risks, and a number of other conditions may be present and common, affecting the identity of the participants and their degree of cohesiveness.

Since the advent of the internet, the concept of community has less geographical limitation, as people can gather virtually in an online community and share common interests regardless of physical location. Prior to the internet, virtual communities (like social or academic organizations) were far more limited by the constraints of available communication and transportation technologies.

Moreover, for centuries charity has been an integral part of society. The ability to donate allows a person to feel connected and a part of advancing a cause they believe in. In today's modern world there are numerous causes but no efficient way to give a person access to support those causes in the course of daily life. The cumbersome donation process today entails: reading about a certain event that a person is passionate about, looking for charities or organizations that might support that particular event, and finally contacting the charity or organization in attempt to donate.

### SUMMARY OF THE INVENTION

The media contains countless images, videos, articles, events, and the like that affect particular communities. Some media demonstrate a negative or adverse impact on a community. For example, media documenting instances of discrimination, such as racism or religious intolerance, reflect a negative impact on the particular racial or religious communities targeted. For some communities, negative media is a daily or even hourly reality.

What is needed is an efficient and easy to use platform for community members to communicate emotions or opinions expressed about online media affecting their community. An effective platform should accommodate the torrent of media by allowing users to express themselves with a minimum of actions and allow others to receive such expressions without interruptions or distractions. Where media is carries a clear negative impact for a particular community, use of the platform to identify the media and express emotions or opinions generates a “misery index” that quantifies the adverse nature of the event or information described in the media for the community. In some embodiments, such an index is generated by the number of expressions of negative emotions or opinions. In other embodiments, such an index is generated by the velocity or rate of expressions of negative emotions or opinions subsequent to media becoming available. In yet other embodiments, such an index is generated by the strength or magnitude of scores associated with expressions of negative emotions or opinions pertaining to particular media.

Donating to a cause is an unnecessarily difficult task. Searching for a particular organization or charity that supports a cause you are passionate for can be both time consuming and challenging. What is needed is an efficient and easy-to-use platform for an individual to donate to a cause they feel strongly about. An effective platform should streamline the donation process and minimize the decision making that occurs when one is deciding which organization or charity to donate to. In some embodiments, such a process is conducted through a mobile application where media consumed by a donor is analyzed and associated with various causes that the donor can donate to. In other embodiments, the process is conducted on a computer where media consumed by a donor is analyzed and associated with various causes that the donor can donate to.

In one aspect, disclosed herein are computer-implemented systems comprising: a digital processing device comprising an operating system configured to perform executable instructions and a memory; a computer program including instructions executable by the digital processing device to create an application for a community comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; and a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community. In some embodiments, the media comprises: text, one or more photos, one or more videos, one or more apps, one or more articles, one or more social media posts, or a combination thereof. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In still further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are non-transitory computer-readable storage media encoded with a computer program including instructions executable by a processor to create a community application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; and a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community. In some embodiments, the media comprises: text, one or more photos, one or more videos, one or more apps, one or more articles, one or more social media posts, or a combination thereof. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In still further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are community misery platforms comprising: a plurality of mobile processors, each configured to provide a mobile application comprising: a software module configured to provide an interface allowing a user to identify online media relevant to the community and identify one or more friends in the community; a software module configured to send a push notification to the one or more identified friends in the community, wherein a push notification comprises identified online media, a link thereto, or both media and a link and is sent via a server, provided that the push notification communicates a negative sentiment directed toward the identified online media regarding an impact on the community; a server processor configured to provide a server application comprising: a software module configured to identify all push notifications sent pertaining to a particular media or topic regarding an impact on the community; and a software module configured to generate a misery index for the community based on the identified push notifications. In some embodiments, the misery index is generated based, at least in part, on the number, velocity, or timing of the identified push notifications. In some embodiments, the misery index is generated based, at least in part, on a user-configured misery score associated with each of the of the identified push notifications. In some embodiments, the misery index is generated based, at least in part, on the type of media associated with each of the of the identified push notifications. In some embodiments, the misery index is generated based, at least in part, on the publisher associated with each of the identified media. In some embodiments, the misery index is generated based, at least in part, on the identity of the user sending each of the of the identified push notifications. In some embodiments, the media comprises: text, one or more photos, one or more videos, one or more apps, one or more articles, one or more social media posts, or a combination thereof. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In still further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are computer-implemented systems comprising: a digital processing device comprising an operating system configured to perform executable instructions and a memory; a computer program including instructions executable by the digital processing device to create a mobile micro impulse philanthropy application comprising: a software module configured to receive and verify funds from a donor to create a pre-funded philanthropic giving account; a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to dynamically associate the giving icon with the cause related to the analyzed media; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments the cause is a person, organization, or charity. In some embodiments, the media is an article, photo, video, blog post, tweet, or social media post. In some embodiments, the single interaction is a click or touch. In some embodiments the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media.

In another aspect, disclosed herein are non-transitory computer-readable storage media encoded with a computer program including instructions executable by a processor to create a mobile micro impulse philanthropy application comprising: a software module configured to receive and verify funds from a donor to create a pre-funded philanthropic giving account; a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to dynamically associate the giving icon with the cause related to the analyzed media; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments the cause is a person, organization, or charity. In some embodiments, the media is an article, photo, video, blog post, tweet, or social media post. In some embodiments, the single interaction is a click or touch. In some embodiments the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media.

In another aspect, disclosed herein is a mobile micro impulse philanthropy application platform comprising: a plurality of mobile processors, each configured to provide a mobile application comprising: a software module configured to present an interface allowing a donor to create and pre-fund a philanthropic giving account; a software module configured to present an interface allowing the donor to configure a donor profile; a software module configured to monitor media consumed by the donor; a software module configured to generate an interactive giving icon; a software module configured to dynamically associate the giving icon with the cause related to the analyzed media; a server processor configured to provide a server application comprising: a software module configured to receive and verify funds from the donor and associate the funds with a donor giving account; a software module configured to automatically analyze media consumed by donor and determine one or more causes of interest for the donor based at least in part on the donor profile and online behavior of the donor; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient associated with the cause; and a software module configured to transfer the funds from the pre-funded philanthropic giving account: to the cause via the authorized recipient, or return the donor funds to the pre-funded philanthropic giving account if an authorized recipient is not identified; and a data storage comprising: donor data consisting the donor profile and online activity; cause data consisting different causes and their association with the media; and donation data consisting of causes the donor donates to. In some embodiments the cause is a person, organization, or charity. In some embodiments, the media is an article, photo, video, blog post, tweet, or social media post. In some embodiments, the single interaction is a click or touch. In some embodiments the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media.

In another aspect, disclosed herein are computer-implemented systems comprising: a digital processing device comprising an operating system configured to perform executable instructions and a memory; a computer program including instructions executable by the digital processing device to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the cause is a person, organization, or charity. In some embodiments, the media is an article, photo, video, blog post, tweet, or social media post. In some embodiments, the software module is configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

In another aspect, disclosed herein are non-transitory computer-readable storage media encoded with a computer program including instructions executable by a processor to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to: generate an interactive giving icon; a software module configured to dynamically associate the giving icon with the cause related to the analyzed media; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the cause is a person, organization, or charity. In some embodiments, the media is an article, photo, video, blog post, tweet, or social media post. In some embodiments, the software module is configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

In another aspect, disclosed herein is a mobile micro impulse philanthropy application platform comprising: a plurality of mobile processors, each configured to provide a mobile application comprising: a software module configured to present an interface allowing the donor to configure a donor profile; a software module configured to dynamically analyze media consumed by the donor to detect relation with a cause; a software module configured to: generate an interactive giving icon; a software module configured to monitor media consumed by the donor; a server processor configured to provide a server application comprising: a software module configured to automatically analyze media consumed by the donor and determine one or more causes of interest for the donor based at least in part on the donor profile and online behavior of the donor; a software module configured to identify an authorized recipient associated with the cause; and a software module configured to transfer the funds from the pre-funded philanthropic giving account: to the cause via the authorized recipient; or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to. In some embodiments, the cause is a person, organization, or charity. In some embodiments, the media is an article, photo, video, blog post, tweet, or social media post. In some embodiments, the software module is configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

In another aspect, disclosed herein are computer-implemented systems comprising: a digital processing device comprising an operating system configured to perform executable instructions and a memory; a computer program including instructions executable by the digital processing device to create an application for a community comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the media comprises text, one or more photos, one or more videos, one or more apps, one or more articles, one or more social media posts, or a combination thereof. In some embodiments, the cause is a person, organization, or charity. In some embodiments, the software module configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of a cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are non-transitory computer-readable storage media encoded with a computer program including instructions executable by a processor to create a community application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of a cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are community misery platforms comprising: a plurality of mobile processors, each configured to provide a mobile application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a server processor configured to provide a server application comprising: a software module configured to identify all push notifications sent pertaining to a particular media or topic regarding an impact on the community; a software module configured to generate a misery index for the community based on the identified push notifications. a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of a cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause. In some embodiments, the push notifications comprise one or more of: an alert message, a sound, and an app icon badge. In some embodiments, the push notifications utilize a constantly open internet protocol (IP) connection to forward notifications from a server to the digital processing device. In some embodiments, the push notifications are presented when the application is running, in the background, or inactive. In further embodiments, the push notifications are presented without the need to open the application. In further embodiments, the push notifications are presented on a lock screen of the processing device. In some embodiments, the community is a business community, a religious community, a racial community, an interest community, or a local community. In further embodiments, the community is the international Jewish community. In some embodiments, the digital processing device is a mobile device and the application is a mobile application. In some embodiments, the push notifications consist of: the identified media, a link thereto, or both the media and a link, and a single word.

In another aspect, disclosed herein are computer-implemented systems comprising: a digital processing device comprising an operating system configured to perform executable instructions and a memory; a computer program including instructions executable by the digital processing device to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to associate the cause with a negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the cause is a person, organization, or charity. In some embodiments, the media is an article, photo, video, blog post, tweet, or social media post. In some embodiments, the software module configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

In another aspect, disclosed herein are non-transitory computer-readable storage media encoded with a computer program including instructions executable by a processor to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to associate the cause with a negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified. In some embodiments, the cause is a person, organization, or charity. In some embodiments, the media is an article, photo, video, blog post, tweet, or social media post. In some embodiments, the software module configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

In another aspect, disclosed herein is a mobile micro impulse philanthropy application platform comprising: a plurality of mobile processors, each configured to provide a mobile application comprising: a software module configured to present an interface allowing the donor to configure a donor profile; a software module configured to dynamically analyze media consumed by the donor to detect relation with a cause; a software module configured to generate an interactive giving icon; a software module configured to monitor media consumed by the donor associating the cause with a negative sentiment directed toward the identified online media regarding an impact on the community; a server processor configured to provide a server application comprising: a software module configured to automatically analyze media consumed by the donor and determine one or more causes of interest for the donor based at least in part on the donor profile and online behavior of the donor; a software module configured to identify an authorized recipient associated with the cause; and a software module configured to transfer the funds from the pre-funded philanthropic giving account to the cause via the authorized recipient, or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to. In some embodiments, the cause is a person, organization, or charity. In some embodiments, the media is an article, photo, video, blog post, tweet, or social media post. In some embodiments, the software module configured to receive an indication from the donor that they would like to give to the cause, the indication the result of a single interaction with the icon. In further embodiments, the single interaction is a click or touch. In some embodiments, the giving icon is associated with a particular element of the media. In some embodiments, the philanthropic giving account is pre-funded prior to identification of the one or more causes of interest. In some embodiments, the application further comprises a software module configured to provide an interface for allowing the donor to configure a donor profile, the donor profile comprising donor rankings of various categories of causes. In some embodiments, the donor profile comprises donor rankings of various categories of causes. In some embodiments, the application further comprises a software module configured to choose the cause when more than one cause is detected to relate to the analyzed media, the decision is based in part on the user's interaction with the application and the donor profile. In some embodiments, the application is implemented through a browser plug-in or extension. In some embodiments, the application is implemented through a mobile interface. In some embodiments, the application is not dependent on human action to initiate the association of the cause with the analyzed media. In some embodiments, the software module is configured to receive and verify funds from a donor to create a pre-funded philanthropic giving account. In some embodiments, the software module is configured to debit the pre-funded philanthropic giving account and hold the funds in trust for the cause.

### BRIEF DESCRIPTION OF THE DRAWINGS

FIG. 1 shows a non-limiting example of a user interface screen for an application described herein; in this case, a log in screen.

FIG. 2 shows a non-limiting example of a user interface screen for an application described herein; in this case, a main screen displaying a list of friends.

FIG. 3 shows a non-limiting example of a user interface screen for an application described herein; in this case, a main screen displaying a list of friends and demonstrating a “block” or “delete” feature.

FIG. 4 shows a non-limiting example of a user interface screen for an application described herein; in this case, a settings screen.

FIG. 5 shows a non-limiting example of a micro impulse philanthropic giving process, in this case, a process demonstrating donating to a cause.

FIG. 6 shows a non-limiting example of a micro impulse philanthropic giving process, in this case, a process demonstrating donating to a cause.

FIG. 7 shows a non-limiting example of a micro impulse philanthropic giving process, in this case, a process demonstrating donating to a cause associated with a negative sentiment.

FIG. 8 shows a non-limiting example of a community, in this case, a process for sending a notification that communicates a negative sentiment and associating that negative sentiment with a cause.

### DETAILED DESCRIPTION OF THE INVENTION

Described herein, in certain embodiments, are computer-implemented systems comprising: a digital processing device comprising an operating system configured to perform executable instructions and a memory; a computer program including instructions executable by the digital processing device to create an application for a community comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; and a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community.

Also described herein, in certain embodiments, are non-transitory computer-readable storage media encoded with a computer program including instructions executable by a processor to create a community application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; and a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community.

Also described herein, in certain embodiments, are community misery platforms comprising: a plurality of mobile processors, each configured to provide a mobile application comprising: a software module configured to provide an interface allowing a user to identify online media relevant to the community and identify one or more friends in the community; a software module configured to send a push notification to the one or more identified friends in the community, wherein a push notification comprises identified online media, a link thereto, or both media and a link and is sent via a server, provided that the push notification communicates a negative sentiment directed toward the identified online media regarding an impact on the community; a server processor configured to provide a server application comprising: a software module configured to identify all push notifications sent pertaining to a particular media or topic regarding an impact on the community; and a software module configured to generate a misery index for the community based on the identified push notifications.

Also described herein, in certain embodiments, are computer-implemented systems comprising: a digital processing device comprising an operating system configured to perform executable instructions and a memory; a computer program including instructions executable by the digital processing device to create a mobile micro impulse philanthropy application comprising: a software module configured to receive and verify funds from a donor to create a pre-funded philanthropic giving account; a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to dynamically associate the giving icon with the cause related to the analyzed media; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, are non-transitory computer-readable storage media encoded with a computer program including instructions executable by a processor to create a mobile micro impulse philanthropy application comprising: a software module configured to receive and verify funds from a donor to create a pre-funded philanthropic giving account; a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to dynamically associate the giving icon with the cause related to the analyzed media; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, a mobile micro impulse philanthropy application platform comprising: a plurality of mobile processors, each configured to provide a mobile application comprising: a software module configured to present an interface allowing a donor to create and pre-fund a philanthropic giving account; a software module configured to present an interface allowing the donor to configure a donor profile; a software module configured to monitor media consumed by the donor; a software module configured to generate an interactive giving icon; a software module configured to dynamically associate the giving icon with the cause related to the analyzed media; a server processor configured to provide a server application comprising: a software module configured to receive and verify funds from the donor and associate the funds with a donor giving account; a software module configured to automatically analyze media consumed by donor and determine one or more causes of interest for the donor based at least in part on the donor profile and online behavior of the donor; a software module configured to receive an indication from the donor that they would like to give to the cause, the indication the result of a single interaction with the icon; a software module configured to debit the pre-funded philanthropic giving account and hold the funds in trust for the cause; a software module configured to identify an authorized recipient associated with the cause; and a software module configured to transfer the funds from the pre-funded philanthropic giving account: to the cause via the authorized recipient, or return the donor funds to the pre-funded philanthropic giving account if an authorized recipient is not identified; and a data storage comprising: donor data consisting the donor profile and online activity; cause data consisting different causes and their association with the media; and donation data consisting of causes the donor donates to.

Also described herein, in certain embodiments, are computer-implemented systems comprising: a digital processing device comprising an operating system configured to perform executable instructions and a memory; a computer program including instructions executable by the digital processing device to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, are non-transitory computer-readable storage media encoded with a computer program including instructions executable by a processor to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to: generate an interactive giving icon; a software module configured to dynamically associate the giving icon with the cause related to the analyzed media; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, a mobile micro impulse philanthropy application platform comprising: a plurality of mobile processors, each configured to provide a mobile application comprising: a software module configured to present an interface allowing the donor to configure a donor profile; a software module configured to dynamically analyze media consumed by the donor to detect relation with a cause; a software module configured to: generate an interactive giving icon; a software module configured to monitor media consumed by the donor; a server processor configured to provide a server application comprising: a software module configured to automatically analyze media consumed by the donor and determine one or more causes of interest for the donor based at least in part on the donor profile and online behavior of the donor; a software module configured to identify an authorized recipient associated with the cause; and a software module configured to transfer the funds from the pre-funded philanthropic giving account: to the cause via the authorized recipient; or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to.

Described herein, in certain embodiments, are computer-implemented systems comprising: a digital processing device comprising an operating system configured to perform executable instructions and a memory; a computer program including instructions executable by the digital processing device to create an application for a community comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, are non-transitory computer-readable storage media encoded with a computer program including instructions executable by a processor to create a community application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, are community misery platforms comprising: a plurality of mobile processors, each configured to provide a mobile application comprising: a software module configured to provide an interface allowing a user to create a list of friends in a community, each friend a user of the application; a software module configured to provide an interface allowing a user to identify online media relevant to the community and identify one or more friends in the community; a software module configured to send a push notification to the one or more identified friends in the community, wherein a sent push notification comprises identified online media, a link thereto, or both media and a link, provided that the push notification communicates a negative sentiment directed toward the identified online media regarding an impact on the community; a software module configured to receive a push notification from a friend in the community, wherein a received push notification comprises online media identified by the friend in the community, a link thereto, or both media and a link, provided that the received push notification communicates a negative sentiment directed toward the identified online media regarding an impact on the community; a server processor configured to provide a server application comprising: a software module configured to identify all push notifications sent pertaining to a particular media or topic regarding an impact on the community; a software module configured to generate a misery index for the community based on the identified push notifications. a software module configured to associate a cause with the negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to.

Also described herein, in certain embodiments, are computer-implemented systems comprising: a digital processing device comprising an operating system configured to perform executable instructions and a memory; a computer program including instructions executable by the digital processing device to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to associate the cause with a negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, are non-transitory computer-readable storage media encoded with a computer program including instructions executable by a processor to create a mobile micro impulse philanthropy application comprising: a software module configured to automatically determine one or more causes of interest for the donor based at least in part on a donor profile and online behavior of the donor; a software module configured to dynamically analyze media consumed by the donor to detect relation with a cause; a software module configured to generate an interactive giving icon; a software module configured to: dynamically associate the giving icon with the cause related to the analyzed media; a software module configured to associate the cause with a negative sentiment directed toward the identified online media regarding an impact on the community; a software module configured to identify an authorized recipient to receive a donation associated with the cause; and a software module configured to transfer the funds from the pre-funded philanthropic giving account to the cause via the authorized recipient, or return the donor funds to the pre-funded philanthropic giving account if an authorized recipient is not identified.

Also described herein, in certain embodiments, a mobile micro impulse philanthropy application platform comprising: a plurality of mobile processors, each configured to provide a mobile application comprising: a software module configured to present an interface allowing the donor to configure a donor profile; a software module configured to dynamically analyze media consumed by the donor to detect relation with a cause; a software module configured to generate an interactive giving icon; a software module configured to monitor media consumed by the donor associating the cause with a negative sentiment directed toward the identified online media regarding an impact on the community; a server processor configured to provide a server application comprising: a software module configured to automatically analyze media consumed by the donor and determine one or more causes of interest for the donor based at least in part on the donor profile and online behavior of the donor; a software module configured to identify an authorized recipient associated with the cause; and a software module configured to transfer the funds from the pre-funded philanthropic giving account to the cause via the authorized recipient, or return the donor funds to the pre-funded philanthropic giving account if an authorized recipient is not identified; a data storage comprising: donor data consisting the donor profile and online activity; cause data consisting different causes and their association with the media; and donation data consisting of causes the donor donates to.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, “community” refers to a social unit of any size that shares common values; for example, a group of people who have the same interests, religion, race, or the like or a group of people who live in the same area (e.g., a city, a town, a neighborhood, etc.).

As used herein, “push notification” refers to an internet-based communication utilizing push technology through a constantly open internet protocol (IP) connection to forward notifications from a server a user device.

### Overview

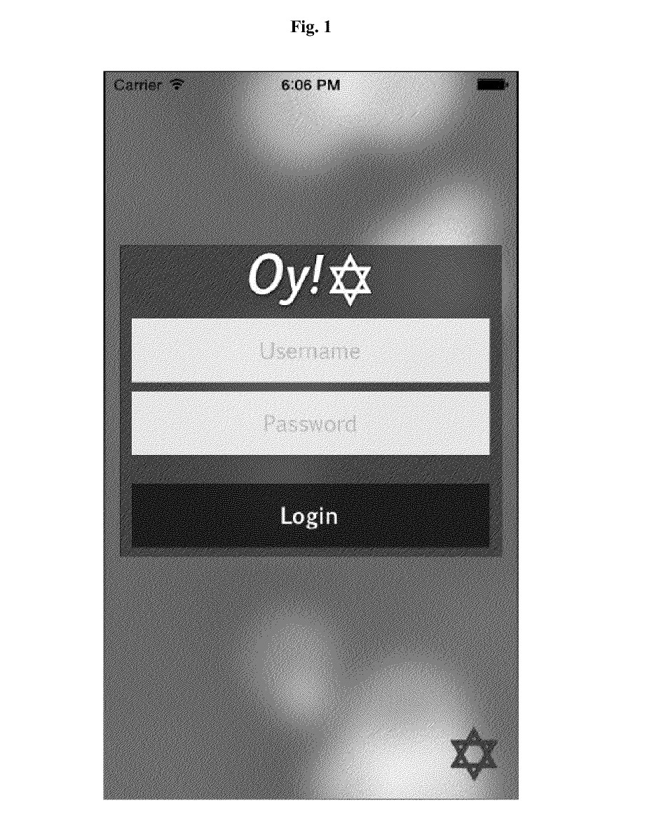

Referring to FIG. 1, in a particular embodiment, the application presents a log in screen to users, which requires entry of a username and password previously configured by the user. In this embodiment, the log in feature remembers the username from the last successful log in. Further in this embodiment, the password is encrypted before storing in a local database and is not sent in plain text (e.g., in the clear) to the server.

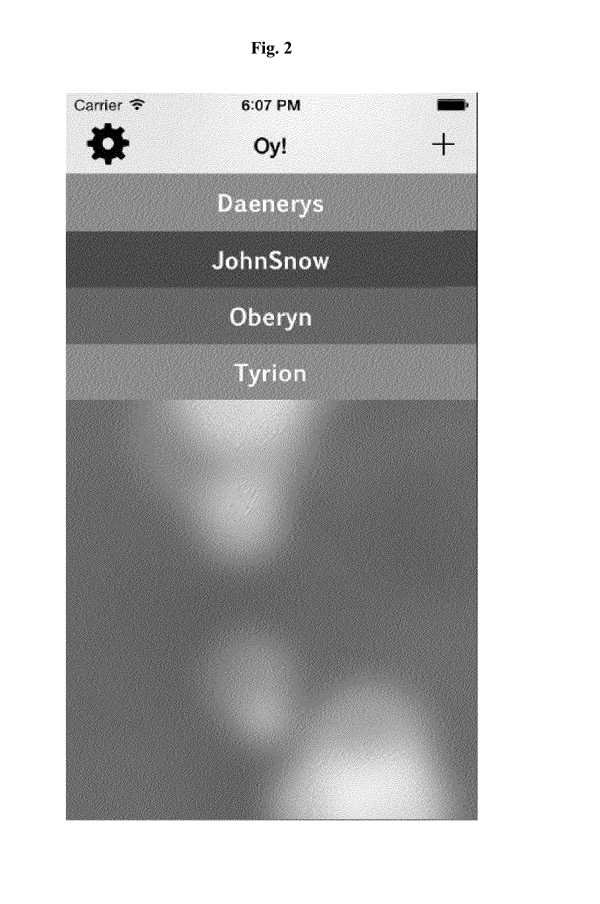

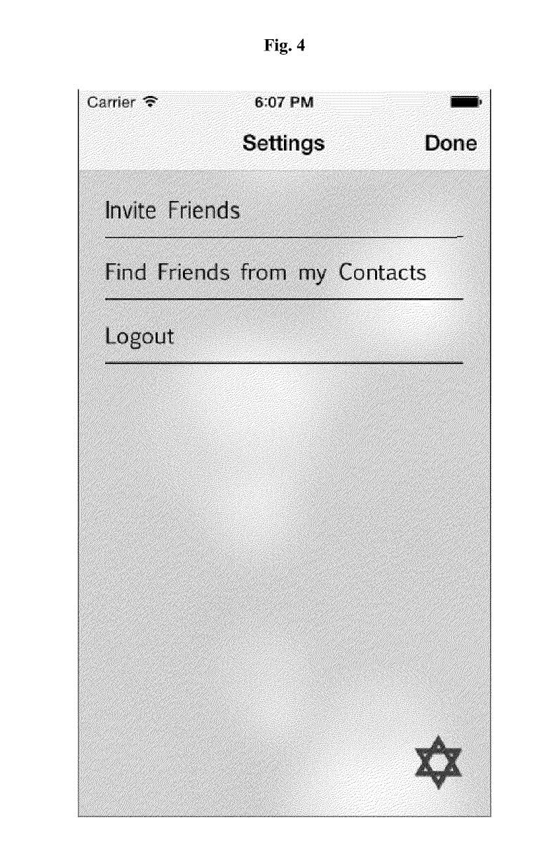

Referring to FIG. 2, in a particular embodiment, the application presents a list of friends to the user. In this embodiment, the list is alphabetical. At the top left of the exemplary list of friends is a “settings” button that navigates to a settings screen (see FIG. 4) and at the top right of the exemplary list of friends is a “add friend” button that allows the user to access a variety of methods for adding new friends. For example, new friends are optionally added by entering a phone number, which is used to match against contacts of other users of the app, or by entering friends phone number, email address, or social media screen name, which is used to send a personalized invitation to download the app or add sending user as a friend, or by simply entering the username of another user of the app.

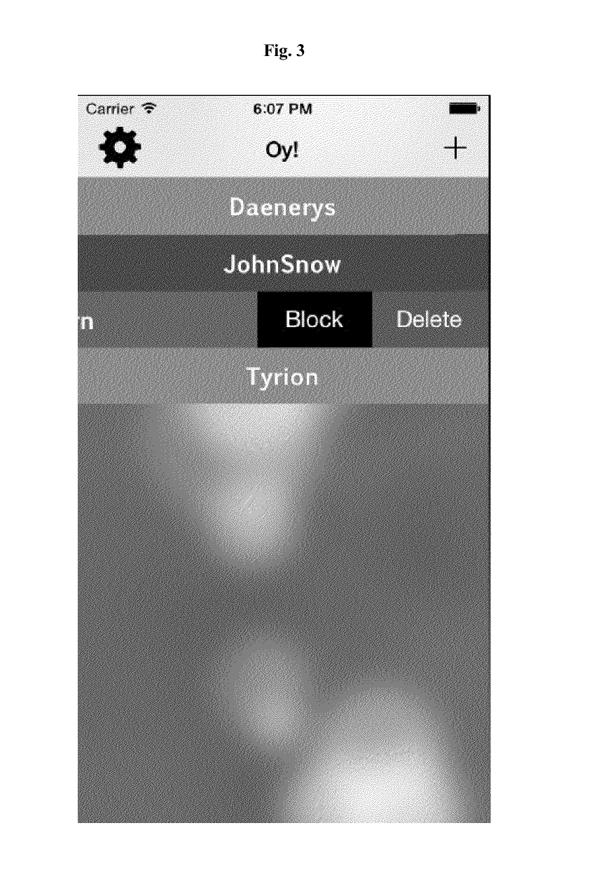

Referring to FIG. 3, in a particular embodiment, the list of friends includes features for blocking (e.g., muting) and/or deleting any particular friend. In this embodiment, the block/delete features are access by swiping to the left across the name of a friend.

Referring to FIG. 4, in a particular embodiment, the application presents a settings screen to the user. In this embodiment, the settings screen allows the user to access the features for adding friends, including features for inviting friends via SMS, email, Facebook, and/or Twitter and features for finding friends among the user's contacts.

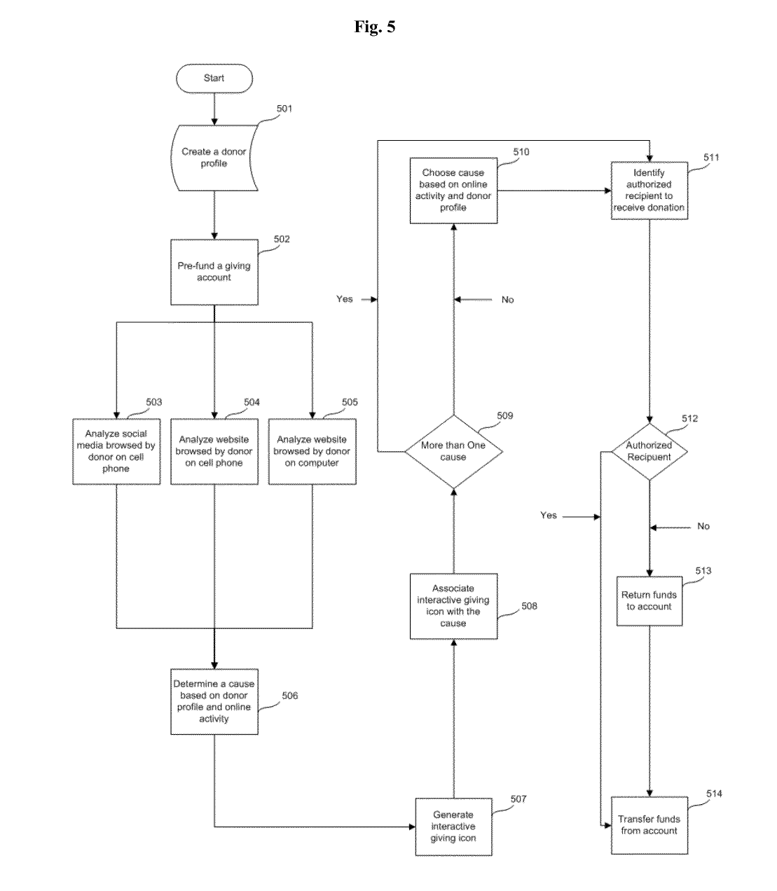

Referring to FIG. 5, in a particular non-limiting embodiment, a donor creates a profile 501. In this embodiment, a pre-funded account is created 502. In this embodiment, the donor browses a website on his cell phone, the website is analyzed 503, or the donor browses a social media on his cell phone, the social media is analyzed 504, or the donor browses a website on his computer, the website is analyzed 505. In this embodiment, a cause is associated with the website or social media based on the donor's online activity and profile 506. In this embodiment, an interactive giving icon is generated 507 and subsequently associated with the cause 508. In this embodiment, if there is more than one cause associated with the website 509 the cause is then selected based on the donor's online activity and donor profile 510. In this embodiment, once a cause is chosen or if there is only one cause found, an authorized recipient is identified 511. If an authorized recipient 512 is found the funds are transferred from the account to the cause 514, if an authorized recipient 512 is not found the funds are returned to the account 513.

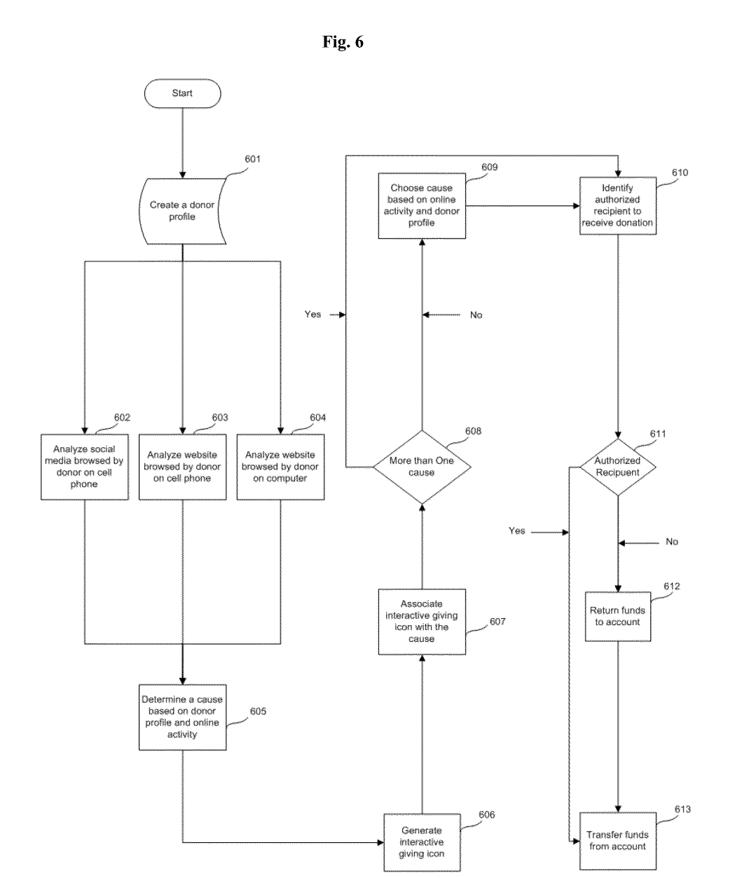

Referring to FIG. 6, in a particular non-limiting embodiment, a donor creates a profile 601 In this embodiment, the donor browses a website on his cell phone, the website is analyzed 602, or the donor browses a social media on his cell phone, the social media is analyzed 603, or the donor browses a website on his computer, the website is analyzed 604. In this embodiment, a cause is associated with the website or social media based on the donor's online activity and profile 605. In this embodiment, an interactive giving icon is generated 606 and subsequently associated with the cause 607. In this embodiment, if there is more than one cause associated with the website 608 the cause is then selected based on the donor's online activity and donor profile 609. In this embodiment, once a cause is chosen or if there is only one cause found, an authorized recipient is identified 610. If an authorized recipient 611 is found the funds are transferred from the account to the cause 613, if an authorized recipient 611 is not found the funds are returned to the account 612.

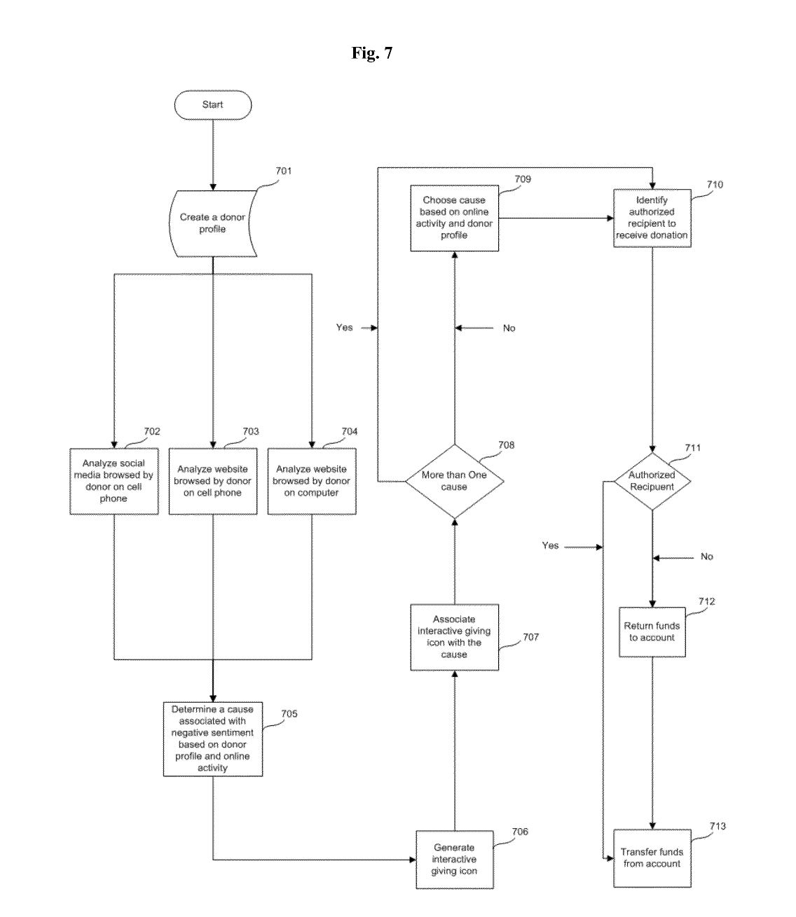

Referring to FIG. 7, in a particular non-limiting embodiment, a donor creates a profile 1101. In this embodiment, the donor browses a website on his cell phone, the website is analyzed 1102. In this embodiment, a cause with a negative sentiment is associated with the website based on the donor's online activity and profile 1103. In this embodiment, an interactive giving icon is generated 1104 and subsequently associated with the cause 1105. In this embodiment, if there is more than one cause associated with the website 1106 the cause is then selected based on the donor's online activity and donor profile 1107. In this embodiment, once a cause is chosen or if there is only one cause found, an authorized recipient is identified 1108. If an authorized recipient 1109 is found the funds are transferred from the account to the cause 1111, if an authorized recipient 1109 is not found the funds are returned to the account 1110.

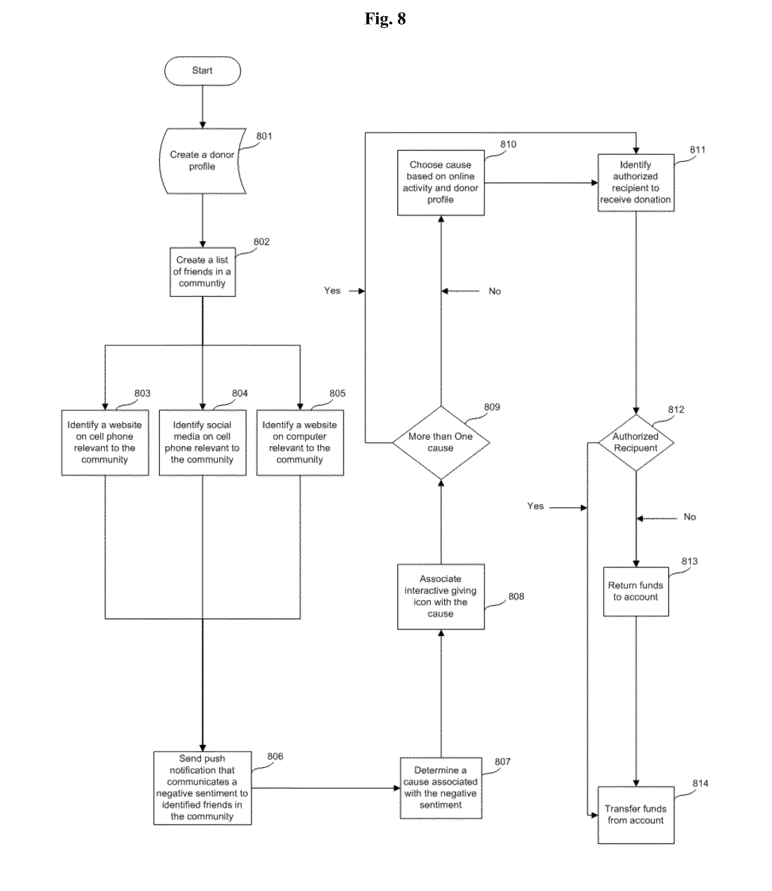

Referring to FIG. 8, in a particular non-limiting embodiment, a user creates a profile 801 and a list of friends in a community 802. In this embodiment, the user identifies a website on his cell phone 803, social media on his cell phone 804, or a website on his computer 805 relative to one or more friends in a community. In this embodiment, the user sends a push notification that communicates a negative sentiment to the identified friend(s) in the community 806. In this embodiment, a cause is determined to be associated with the negative sentiment 807 and an interactive giving icon is associated with the cause 808. In this embodiment, if there is more than one cause associated with the website 809 the cause is then selected based on the donor's online activity and donor profile 810. In this embodiment, once a cause is chosen or if there is only one cause found, an authorized recipient is identified 811. If an authorized recipient 812 is found the funds are transferred from the account to the cause 814, if an authorized recipient 812 is not found the funds are returned to the account 813.

### Identifying Online Media

In some embodiments, the platforms, systems, media, and methods described herein include a software module for allowing a user to identify online media and/or use of the same. Many types of media are suitable for identification as are many formats for each media type. In various embodiments, suitable media includes, by way of non-limiting examples, web pages, web sites, and URLs (e.g., top level domains, directory level URLs, and document level URLs, etc.). In further various embodiments, suitable media includes, by way of non-limiting examples, text files, e-book files, audio files, image files (e.g., photographs, illustrations, screen captures, etc.), video files (e.g., screen capture video, etc.), multimedia files (e.g., interactive applications, games, etc.), executable files (e.g., applications, etc.), and combinations thereof.

Many text formats are suitable including, by way of non-limiting examples, Rich Text Format (RTF), TXT, and HTML formatted text.

Many e-book formats are suitable including, by way of non-limiting examples, plain text, hypertext markup language (HTML), Amazon® Kindle™, Open Electronic Package, TomeRaider, Arghos Diffusion, Flip Books, ANSI/NIS® Z39.86 (DAISY), FictionBook, Text Encoding Initiative, Plucker, Compressed HM, Portable Document Format, PostScript, DjVu, Microsoft LIT, eReader, Desktop Author, Newton eBook, Founder Electronics, Libris, Mobipocket, EPUB, Broadband eBooks (BBeB), SSReader, TealDoc, IEC 62448, and Comic Book Archive file. Suitable e-books include those formatted for viewing on, by way of non-limiting examples, Apple® iPad®, Amazon® Kindle™, Barnes & Noble Nook™, Sony® Reader™, iRex iLiad, the Jinke Hanlin eReader, Bookeen CyBook, Endless Ideas BeBook, and the Kobo™ eReader.

Many audio formats are suitable including, by way of non-limiting examples, MP3, WAV, AIFF, AU, Apple® Lossless, MPEG-4, Windows Media®, Vorbis, AAC, and Real Audio®.

Many video formats are suitable including, by way of non-limiting examples, Windows Media Video (WMV), Motion Picture Experts Group (MPEG), Audio Video Interleave (AVI), QuickTime®, Real Media®, and Windows Media®. In some embodiments, the images and/or videos are uncompressed (e.g., RAW format). In other embodiments, images and/or videos are compressed. Both lossy and lossless video CODECs are suitable including, by way of non-limiting examples, Cineform, Cinepak, Dirac, DV, FFV1, H.263, H.264, H.264 lossless, JPEG 2000, MPEG-1, MPEG-2, MPEG-4, On2 Technologies (VP5, VP6, VP7, and VP8), RealVideo, Snow lossless, Sorenson Video, Theora, and Windows Media Video (WMV).

Many multimedia formats are suitable including, by way of non-limiting examples, Adobe® Flash®, Apple® QuickTime®, Microsoft® Silverlight®, Java™, HTML 5, XHTML 5, and Unity®.

In some embodiments, a software module for identifying media is activated by a user in response to a user interaction. In some embodiments, a user identifies media using a pointing device including, by way of non-limiting examples, a mouse, trackball, trackpad, joystick, pen, or stylus. In further embodiments, a user identifies media with a pointing device by actions including, by way of non-limiting examples, click, click and hold, double click, right click, shift-click, control-click, command-click, drag, draw, and highlight. In some embodiments, a user identifies media using a touch screen display or multi-touch screen display. In further embodiments, a user identifies media with a touch screen or multi-touch screen by gestures including, by way of non-limiting examples, tap (e.g., touch), double tap, tap (e.g., touch) and hold, swipe, drag, pinch, reverse pinch, draw, and highlight. In some embodiments, a user identifies media using a keyboard, keypad, or alternative text input device, by keystroke, combination of keystrokes, or sequence of keystrokes. In other embodiments, a user identifies media using a microphone to capture voice (e.g., voice command, etc.) or other sound input. In other embodiments, a user identifies media using a video camera or other device (e.g., Leap Motion) to capture motion or visual input.

In a particular non-limiting embodiment, a user identifies media by using a mouse to click and hold on an image in a web page. In another particular non-limiting embodiment, a user identifies media by using a touch screen display to touch and hold on a video on a web page. In yet another particular non-limiting embodiment, a user identifies media by highlighting text with a mouse and executing a keystroke. In yet another particular non-limiting embodiment, a user identifies media by executing a voice command to create a screen capture image. In yet another particular non-limiting embodiment, a user identifies media by using a stylus to draw a box around a portion of a blog post.

In some embodiments, the identified media is relevant to a particular community to which the identifying user belongs. In some embodiments, the identified media is relevant to a particular community to which the receiving user belongs. In further embodiments, the identified media depicts, communicates, or represents a negative impact on the community. In still further embodiments, the community is a business community, a religious community, a racial community, an interest-based community, or a local community. In some embodiments, the identified online media, a link thereto, or both media and a link, is provided to another user via a push notification.

### Push Notification

In some embodiments, the platforms, systems, media, and methods described herein include a software module configured to send a push notification to the one or more identified friends that belong to a particular community. In further embodiments, the push notification comprises identified online media, a link thereto, or both media and a link. In a particular embodiment, the push notification consists of or consists essentially of the media (or a link) and a single word. In various embodiments, the push notification further comprises the username of the user sending the notification and/or an indication of when the notification was sent. In still further embodiments, the push notification communicates a negative sentiment directed toward the identified online media regarding an impact on the community.

In various embodiments, the push notifications comprise: an alert message, a sound, an app icon badge, or a combination thereof. In some embodiments, the push notifications utilize a constantly open internet protocol (IP) connection to forward notifications from a server to the digital processing device. In further embodiments, the push notifications are presented when the application is running, in the background, or inactive. In still further embodiments, the push notifications are presented without the need to open the application and are optionally presented on a lock screen of the processing device.

### Misery Index for a Community

In some embodiments, the platforms, systems, media, and methods described herein a server processor configured to provide a server application comprising a software module configured to identify all push notifications sent pertaining to a particular media or topic regarding an impact on a particular community and a software module configured to generate a misery index for the community based on the identified push notifications.

In various embodiments, the misery index is generated on the basis of one or more properties of the push notifications. By way of example, in some embodiments, the misery index is generated based, at least in part, on the number, velocity, or timing of the identified push notifications. By way of further example, in some embodiments, the misery index is generated based, at least in part, on a user-configured misery score associated with each of the of the identified push notifications. In such embodiments, in addition to identifying online media a user sending a push notification provides a score, rank, or other scaled indicator, which associates a misery score with the identified media. By way of further example, in some embodiments, the misery index is generated based, at least in part, on the type of media associated with each of the of the identified push notifications. By way of still further example, in some embodiments, the misery index is generated based, at least in part, on the publisher associated with each of the identified media. By way of still further example, in some embodiments, the misery index is generated based, at least in part, on the identity of the user sending each of the of the identified push notifications.

### Mobile Micro Impulse Philanthropy Application

In some embodiments, the platforms, systems, media, and methods disclosed herein include a computer program including instructions executable by the digital processing device to create a mobile micro impulse philanthropy application. The mobile aspect of the application creates an opportunity for a donor to give to a cause whenever and wherever they may want. In some embodiments, a donor donates to a cause through an application on a cell phone. The micro aspect of this application serves to expand the accessibility of donating to a cause. Creating an opportunity for people to donate in smaller denominations captures another demographic of potential donors.

For example, in various embodiments, the donation amount can be 1, 2, 3, 4, 5, 6, 7, 8, 9, 10, 15, 20, 25, 30, 35, 40, 45, 50, 55, 60, 65, 70, 75, 80, 85, 90, 95, or 100 cents, including increments therein, or a fraction of a cent. By way of further example, in various further embodiments, the donation amount can be 1, 2, 3, 4, 5, 6, 7, 8, 9, 10, 11, 12, 13, 14, 15, 16, 17, 18, 19 or 20 dollars. By way of further example, in various embodiments, the donation amount can be 20, 30, 40, 50, 60, 70, 80, 90, or 100 dollars, including increments therein. Lastly the impulse aspect of this application caters to the fast paced society that we live in. This application allows people to donate to a cause without going through the process of determining what they want to give to and subsequently how to give to that cause. Instead it allows for donation in real time or on the whim of the donor.

Many implementations are suitable for the application. By way of example, in some embodiments, the mobile micro impulse philanthropy application is an application on a cell phone (e.g., a mobile native application). In some embodiments, the mobile micro impulse philanthropy application is a browser extension on a cell phone. In some embodiments, the mobile micro impulse philanthropy application is an application on a tablet. In other embodiments, the mobile micro impulse philanthropy application is a browser extension, add-in, or plug-in. In other embodiments, the mobile micro impulse philanthropy application is an application on a computer.

### Pre-Funded Philanthropic Account

In some embodiments, the platforms, systems, media, and methods disclosed herein include at least one pre-funded philanthropic account. A pre-funded philanthropic account is an account that a donor can fund with money that can subsequently be used for donations. Many types of accounts are suitable. For example, in some embodiments, a pre-funded philanthropic account is a Venmo account. In some embodiments, a pre-funded philanthropic account is a donor's checking account. In other embodiments, a pre-funded philanthropic account is a donor's savings account. In some embodiments, a pre-funded philanthropic account is a Google wallet account. In further embodiments, a pre-funded philanthropic account is an Apple pay account. In some embodiments, a pre-funded philanthropic account is an account maintained through the application. In yet a further embodiment, a pre-funded philanthropic account is a credit card.

### Determining One or More Causes

In some embodiments, the platforms, systems, media, and methods described herein include a software module configured to determine one or more causes of interest for the donor. Suitable causes include but are not limited to charities, organizations, or people. The data used to determine a cause includes, but is not limited to, online content consumed by a donor and information stored in one or more donor profiles.

In some embodiments, the data used to determine the cause is the donor profile. In some embodiments, the data used to determine the cause is the donor's social media posting history. In other embodiments, the data used to determine the cause is the donor's news source preference. In further embodiments, the data used to determine the cause is the donor's profile and online search history. In yet a further embodiment, the data used to determine the cause is a donor's cause preferences stored in the donor profile and social media activity.

In a particular embodiment, the cause is the American Red Cross. In another particular embodiment the cause is the World Health Organization. In another particular embodiment, the cause is the NAACP. In yet another particular embodiment, the cause is the American Cancer Society.

In one particular embodiment, the cause is an individual burnt in a fire. In another particular embodiment, the cause is the family of an individual burnt in a fire. In another particular embodiment, the cause is a person in need of funds for cancer treatment.

### Analyzing Media

In some embodiments, the platforms, systems, media, and methods described herein include a software module configured to dynamically analyze media consumed by the donor to detect relation with a cause. By way of example, the consumed media is analyzed to detect what causes are associated as well as of the associated causes what the donor will donate to. In some embodiments, the analyzed media consists of online content that the donor consumes. In some embodiments, the analyzed media is on the donor's computer. In other embodiments the analyzed media is within an app on the donor's cell phone. In further embodiments the analyzed media is on a donor's cell phone.

In other embodiments, the analysis of the consumed media consists of looking for the names of specific causes within the consumed media. In further embodiments, the analysis of the consumed media consists of searching the consumed media for certain keywords associated with a specific cause. In yet a further embodiment, the analysis of the consumed media consists of searching for keywords associated with causes from the donor profile.

In some embodiments, the analysis of the consumed media consists of keyword parsing. In some embodiments, the analysis of the consumed media consists of searching the donor's most donated causes. In further embodiments, the analysis of the consumed media consists of comparing a donor's search history keywords with the consumed media. In yet a further embodiment, the analysis of the consumed media consists of comparing a donor's social media with the consumed media.

In a particular embodiment, the analyzed media is a news article on a website. In another particular embodiment, the analyzed media is a Facebook post. In another particular embodiment, the analyzed media is a tweet. In another particular embodiment, the analyzed media is a Google Plus post. In yet another particular embodiment, the analyzed media is a YouTube video. In yet another particular embodiment, the analyzed media is a buzfeed blog post. In yet another particular embodiment, the analyzed media is an Instagram photo.

### Generating an Interactive Giving Icon

In some embodiments, the platforms, systems, media and methods described herein include a software module configured to generate an interactive giving icon. In some embodiments the interactive giving icon comprises a graphic icon. In further embodiments the interactive giving icon comprises a shape. In other embodiments, the interactive giving icon comprises a picture. In some embodiments, the interactive giving icon comprises a sound. In some embodiments, the interactive giving icon comprises a color. In yet a further embodiment, the interactive giving icon comprises an animation. In some embodiments, the interactive giving icon comprises a video.

Associating the Giving Icon with Media

In some embodiments, the platforms, systems, media and methods described herein include a software module configured to associate the interactive giving icon with media. In some embodiments, one interactive giving icon is associated with the consumed media. In other embodiments, any suitable number of interactive giving icons are associated with the consumed media. For example, in various embodiments, 1, 2, 3, 4, 5, 6, 7, 8, 9, 10, or more interactive giving icons are associated with the consumed media. By way of further examples, in various embodiments, 20, 30, 40, 50, 60, 70, 80, 90, 100, or more interactive giving icons, including increments therein, are associated with the consumed media.

In yet a further embodiment, the interactive giving icon is placed on the right side of the consumed media. In some embodiments, the interactive giving icon is placed on the left side of the consumed media. In other embodiments, the interactive giving icon is placed at the top of the consumed media. In further embodiments, the interactive giving icon is placed on the bottom of the consumed media. In various embodiments, the interactive giving icons are spaced evenly throughout the consumed media. In other embodiments, the interactive giving icons are spaced unevenly throughout the consumed media. In some embodiments, the interactive giving icon is placed next to a particular word. In some embodiments, the interactive giving icon is placed next to a picture. In other embodiments, the interactive giving icon is placed next to a video.

Indication from the Donor

In some embodiments, the platforms, systems, media and methods described herein include a software module configured to receive an indication from the donor that they would like to give to the cause. In some embodiments, the indication is a click. In some embodiments, the indication is a touch. In some embodiments, the indication is a key stroke. In further embodiments, the indication is a visual cue. In some embodiments, the indication is verbal. In some embodiments, the indication is a wave.

### Authorized Recipient

In some embodiments, the platforms, systems, media and methods described herein include a software module configured to identify an authorized recipient to receive the donation. In some embodiments, the authorized recipient is an officer of an organization. In some embodiments, the authorized recipient is an employee of the charity. In some embodiments, the authorized recipient is Kickstarter. In other embodiments, the authorized recipient is a third party website authorized to receive funds on behalf of a cause. In other embodiments, the authorized recipient is a third party company authorized to receive funds on behalf of the charity. In some embodiments, the authorized recipient is the organization itself. In further embodiments, the authorized recipient is the charity.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile OS, Linux®, and Palm WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, media, and push notification information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Example 1

### Matching Methodology

In this example, “content” or “news” means an online news article, blog post, or other online content with which is associated a giving icon. Further, in this example, “charity” means the nonprofit organization that is eligible for receiving donations and a “charity” is a type of “cause” described herein. Further, in this example, “sector” means the group of charities that can be seen as serving the same community, such as breast cancer research, or homelessness in San Diego. Further, in this example, “match” means the charities recommended for given content. Last, in this example, “classifier” means the process in which a machine reads text in the content and the mission statements and websites of charities to probabilistically ascertain the meaning of text.

In some embodiments, a key objective is to find the best “match” between content and one or charities or a sector. In further embodiments, the best match incorporates a combination of the appropriateness, effectiveness, and popularity of the charity. In this example, “appropriateness” means the charity fits with the issues discussed in the content. In this example, “effectiveness” means the quality and reputation of the charities. In some embodiments, the measure of quality commonly used is effectiveness or the success with which they meet their mission. Because success is always not comparable across organizations with different missions, in further embodiments, we keep our scores relative to the best in a “sector.” In this example “popularity” means the appeal of the charity to donors.

Appropriateness: Tags

In some embodiments, each content item and each charity are “tagged” with words that are drawn from a defined list that is intended to capture the universe of words and/or phrases that could be used to select the “giving-relevant” aspects of content or charity. In some cases, we call these words “tags.” The tags do not need to be words that appear in either the content or charity's mission statement or web page. For example, in some embodiments, the tags are strategically selected by humans to help facilitate the match.

In various embodiments, suitable tags are words from categories that describe the beneficiaries, for example children, adults, elderly, families, animals, pets, dogs, cats, etc., their need or challenge, for example, education, employment, housing, cancer, lung cancer, pancreatic cancer, breast cancer, depression, safety, disaster relief, skills, legal protection, civil rights, etc., and the way the charity fills their need, for example, scholarships, teachers, medical services, medical research, emotional support, counseling, direct aid, training, legal advice, legal representation, spay and neuter, animal rescue, etc. In some embodiments, the tags are arranged in a hierarchical structure. For example, after first choosing that the beneficiaries are, say, animals and dogs, then there is no reason to offer them scholarships or legal training, but we limit the next choices to pet adoption, pet rescue, spay and neuter, and so on.

Appropriateness: Memes

The described methodology is flexible enough to handle cases where there is not a 1-to-1 match between tags associated with the content and tags associated with the charities. If we do not have identical sets of tags for both sides of the match, we optionally create a linguistic filter that take elements or subsets of the tags and creates common “filtered tags” that are meant to capture common intent or common language. We call an element of this common language a “meme,” and the set of all memes W. More specifically, there is a mapping F_{N} that takes as inputs all the tags associated with content and creates outputs wₕ εW. Every tag associated with content is attached to at least one element of W and every element of W is associated with at least one tag associated with content. Similarly, there is optionally a linguistic mapping from the tags on charities, F_{C} that takes as inputs all the tags associated with charities and creates outputs wₕ εW. Every tag associated with content is attached to at least one element of W and every element of W is associated with at least one tag associated with content. In this example, where “memes” is used, it means all tags have been filtered to represent the appropriate memes, and thus there is a common language to use for matching content and charities.

Define the following notation:

W=a set containing the universe of memes (filtered tags).

N⊂W=the set of memes applied to news/content piece online.

N=the set of memes applied to news/content piece online.

nⱼεN=a particular meme in N.

C=the set of memes applied to all charities.

cᵢ^{k}εC=a particular meme in C^{k}.

M=a set of common meanings that charities and content can match on.

M^{k}=N∩C^{k}, which is the set of memes that charity k will have in common with the news/content.

e^{k}=the effectiveness factor applied to charity k.

p^{k}=the popularity factor applied to charity k.

s(k)=is a factor that weights the effectiveness in a way that makes it comparable across sectors.

θ^{k}=s(k)e^{k}+p^{k} is the weighting factor put on a match between a charity and a news/content piece to reflect effectiveness and popularity of charity k that operates in sector s(k).

In some cases, a challenge overcome by the subject matter described herein is how to how to match the content to the charities based on the memes. The intuition for the solution is that we think of the content as having a “value” for each meme associated with the content, and it is searching for the charity whose memes have the greatest value for the content. On the other side, we have charities who also have different values for different memes, and the charities are looking for news content that has the memes that are most valuable to the charity. The best match is the content-charity pair that has the highest total value. The value of the charity to the news content and the value of the content to charity have the highest total value. Using this rule assures the greatest appropriateness of the match.

When the classifier is selecting best tags for a particular content, it optionally assigns a relative predictive power for each tag. These predictive powers are optionally carried through to the memes. Likewise for the charities. Thus the classifier, the tags, and the linguistic filters produce numbers that are optionally interpreted as the predictive value of the memes for the content and for the charity.

In cases where we are matching a single piece of content with a set of charities, we only need to examine the set of memes common to both the content and any charities.

Define the following:

ηⱼ=η(nⱼ), 0≦ηⱼ≦1, is the weight applied to an nⱼε [symbol] such that ηⱼ≧0 for all j and Σηⱼ=1.

χⱼ=χ(cᵢ^{k}), 0≦χⱼ≦1, is the weight applied to an cᵢ^{k}ε [symbol] ^{k} such that χᵢ^{k}≧0 for all i and Σ₁χᵢ^{k}=1.

In some embodiments, the weights are determined by the classifier for the news content, η( ) and by the classifier for the charity, χ( ) In further embodiments, rather than setting the lower bounds of η and χ to be zero, we optionally require a slightly greater lower bound, such that ηi and χi are renormalized to sum to 1. Or, alternatively, we reserve tightening of the lower bounds until further in the process, as described below. In still further embodiments, we have the discretion to use both sources in order to improve the quality of the matches.

We now optionally calculate the value of a match between a charity and content. Let m₃^{k}εM be an element of the intersection of the words selected for the content and for the charity. Then let μ^{k} be the value of the match between the content and charity k. We calculate μ^{k} by first defining μ^{k} as

$${m}^{k} = max \{ {\sum }_{{m}_{i} ∈ {ℳ}^{k} } η ( {m}_{i} ) {χ}_{i}^{k} ( {m}_{i} ) - \overline{m} , 0 \} ,$$

where m̅ is a lower bound chosen to increase the certainty of our matches.

We then repeat this for all k=1, K charities, finding m¹, . . . , m^{k}. Now we want to include a weighting based on effectiveness and popularity. Now we employ the θ^{k} that comes from the effectiveness and popularity ratings, and create a weighted score θ^{k}m^{k}. Next we want to normalize this weighted score. To do this, define

$$M = {\sum }_{k = 1}^{K} {θ}^{k} {m}^{k} .$$

We can now define μ^{k} as

$${μ}^{k} = \frac{{θ}^{k} {m}^{k}}{M}$$

$$so {μ}^{k} \geq 0 and {\sum }_{k = 1}^{K} {μ}_{k} = 1.$$

Alternative-Style Recommendation

The set Π={μ¹, . . . , μ^{K}} represents a probability distribution from with charities can be drawn for our Pandora Style recommending system.

Note, Π is optionally altered by adjustments to the θ^{k} function. For example, in some embodiments, we make adjustments to advantage small and inventive charities, put a cap the weight put on the set of already rich charities, or to highlight especially effective charities.

Personalizing: Updating μ^{k} for Each Donor

For the purposes of example, let's rename the charities so that μ¹≧μ²≧ . . . ≧μ^{K}. Thus, charity 1 will be recommended most often. Suppose we recommended three charities such that μ^{a}>μ^{b}>μ^{c}, but the user chooses charity b rather than charity a. In such cases, we know to adjust the weights on charities a and b and c to reflect the imprecision in our model with predicting the choice of this particular user. We will make the adjustments using Bayesian methods that account for the degree of variance in our predictions and the variance in the actions of the user.

Effectiveness and Popularity: Estimating e^{k}, p^{k}, and s(k)

In some cases, another challenge overcome by the subject matter described herein is how to measure the weighting parameter e^{k} on effectiveness. In some embodiments, we do this by adopting subjective assessments of the performance and relative effectiveness of charities. In further embodiments, we use surveys, peer rankings, and opinions of experts to identify a candidate set of “the very best” charities. Then applying techniques of econometrics, we optionally create a predictive model that takes as inputs the following:

Objective data from 990 tax return forms of the charities;

Objective data from Internet contacts with the organizations, such as Facebook likes, Twitter followers, and Alexa ranking;

Ratings of accountability from other charity rating services;

Other subjective ratings by experts on the qualities of the charity, its management, and other subjective estimates of performance; and

Other publicly available data.

In some embodiments, using an econometric model, we estimate a function that will reveal the way to combine available information on charities to best replicate the subjective assessments provided. We will apply this model to the universe of charities to predict their rankings. This will identify a subset of all charities in a given sector that will be candidates for our list of “the very best charities.” Any deviations from our raters' subjective rankings will optionally generate an inspection by an actual human who will examine the records, perhaps interview the charities, and possibly seek more advice from experts on a new round of ratings and a new set of selected charities.

In some embodiments, the popularity score, p^{k} is judged by a combination of Internet attention, such as the Alexa ranking of their web page, Facebook likes, and Twitter followers, but also on subjective ratings of how well their webpage and photo look to raters. In some embodiments, these factors are already entered into their effectiveness calculations. Here we recognize that to be a success at recommending charities, it is not enough to recommend the best quality charities, but we must also recommend charities that individuals would appear to like, and thus build their loyalty to the system described herein. For this reason, we, in some cases, view this exercise as setting a starting point for adjusting the weights for recommending charities to reflect the realities of markets and the superficial frailties of consumers.

### Mapping Ordinal Rankings to Cardinal Probabilities

In some embodiments, the subjective ratings used to calculate e^{k} are ordinal (that is, they only provide a weak ranking). By using rankings to influence the probability of having a charity recommended, we are using them in a cardinal fashion (that is, we are taking a position on how much one charity may be better than another, not just that it is better). Thus, in such embodiments, are forced to make a statement about the equivalence between $10 going to charity 1 and $X going to charity k.

Again, we want to let the data tell us what these cardinal differences should be. In this context, this means that, in some embodiments, we adjust our popularity weights continuously such that the probability with which a charity is recommended is as close to the probability it is selected as possible. By constantly updating our weights to make this true, we will be reflecting the preferences of our users most accurately and most productively.

Recommendations that Include More than One Sector

In some embodiments, we compare effectiveness across sectors. For example, if a content item, such as a news story, reports on how dirty water causes worms in developing nations, then we can recommend charities that promote clean water or that help with de-worming. The most effective clean-water charity may not be as effective as the best de-worming charity. As such, we optionally apply to a sector a weight s(k) where s(k)=sⱼ for all charities k in sector j. Then θₖ=s(k)eₖ+pₖ. Sometimes science will help identify these, but this will be very rare. Rather, it be likely be something that we learn from the data on choice by experimentation. It is optionally factored into ratings systems through subjective questions. Finally, we optionally infer something from the relative sizes of the sectors and what this implies about the public's the perceived view of effectiveness of the charity. This analysis can also be supplemented with subjective questionnaire data on experts who can be asked to rate the relative effectiveness of different pairs of charities that may often intersect on news stories.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system comprising:
a) a digital processing device comprising an operating system configured to perform executable instructions and a memory;
b) a computer program including instructions executable by the digital processing device to create a micro impulse philanthropy application comprising:
i) a software module configured to automatically determine one or more causes of interest for the donor based at least in part on a donor profile and online behavior of the donor;
ii) a software module configured to dynamically analyze media consumed by the donor to detect relation with a cause;
iii) a software module configured to generate an interactive giving icon;
iv) a software module configured to dynamically associate the giving icon with the cause related to the analyzed media;
v) a software module configured to identify an authorized recipient to receive a donation associated with the cause; and
vi) a software module configured to transfer the funds from the pre-funded philanthropic giving account:
1) to the cause via the authorized recipient; or
2) return the donor funds to the pre-funded philanthropic giving account if an authorized recipient is not identified.

2. The system of claim 1, wherein the cause is a person, organization, or charity.

3. The system of claim 1, wherein the media is an article, photo, video, blog post, tweet, or social media post.

4. The system of claim 1, wherein the software module configured to receive an indication from the donor that they would like to give to the cause, the indication the result of a single interaction with the icon;

5. The system of claim 4, wherein the single interaction is a click or touch.

6. The system of claim 1, wherein the giving icon is associated with a particular element of the media.

7. The system of claim 1, wherein the philanthropic giving account is pre-funded prior to identification of the one or more causes of interest.

8. The system of claim 1, wherein the application further comprises a software module configured to provide an interface for allowing the donor to configure a donor profile, the donor profile comprising donor rankings of various categories of causes.

9. The system of claim 1, wherein the donor profile comprises donor rankings of various categories of causes.

10. The system of claim 1, wherein the application further comprises a software module configured to choose the cause when more than one cause is detected to relate to the analyzed media, the decision is based in part on the user's interaction with the application and the donor profile.

11. The system of claim 1, wherein the application is implemented through a browser plug-in or extension.

12. The system of claim 1, wherein the application is a mobile application implemented through a mobile interface.

13. The system of claim 1, wherein the application is not dependent on human action to initiate the association of the cause with the analyzed media.

14. The system of claim 1, wherein the software module is configured to receive and verify funds from a donor to create a pre-funded philanthropic giving account.

15. The system of claim 1, wherein the software module is configured to debit the pre-funded philanthropic giving account and hold the funds in trust for the cause.

16.-30. (canceled)

31. A computer-implemented method of conducting micro impulse philanthropy comprising:
a) automatically determining, by a computer, one or more causes of interest for the donor based at least in part on a donor profile and online behavior of the donor;
b) automatically analyzing, by the computer, media consumed by the donor to detect association with a cause of interest;
c) generating, by the computer, an interactive giving icon;
d) dynamically associating, by the computer, the giving icon with the media;
e) identifying, by the computer, an authorized recipient associated with the cause; and
f) transferring, by the computer, the funds from the pre-funded philanthropic giving account:
i) to the cause via the authorized recipient; or
ii) return the donor funds to the pre-funded philanthropic giving account if an authorized recipient is not identified.

32. The method of claim 31, wherein the cause is a person, organization, or charity.

33. The method of claim 31, wherein the media is an article, photo, video, blog post, tweet, or social media post.

34. The method of claim 31, wherein the computer receives and verifies funds from a donor to create a pre-funded philanthropic giving account.

35. The method of claim 31, wherein the computer debits the pre-funded philanthropic giving account and hold the funds in trust for the cause.

36. The method of claim 31, wherein the computer receives, by the computer, an indication from the donor that they would like to give to the cause, the indication the result of a single interaction with the icon.

37. The method of claim 36, wherein the single interaction is a click or touch.

38. The method of claim 31, wherein the giving icon is associated with a particular element of the media.

39. The method of claim 31, wherein the philanthropic giving account is pre-funded prior to identification of the one or more causes of interest.

40. The method of claim 31, further comprising providing interface for allowing the donor to configure a donor profile, the donor profile comprising donor rankings of various categories of causes.

41. The method of claim 31, further comprising providing a software module configured to automatically choose the cause when more than one cause is detected to relate to the analyzed media, the decision is based in part on the user's interaction with the application and the donor profile.

42. The method of claim 31, wherein the method is not dependent on human action to initiate the association of the cause with the analyzed media.

43. A platform comprising:
a) a processor configured to provide an application comprising:
i) a software module configured to present an interface allowing the donor to configure a donor profile;
ii) a software module configured to: dynamically analyze media consumed by the donor to detect relation with a cause;
iii) a software module configured to: generate an interactive giving icon; and
iv) a software module configured to: monitor media consumed by the donor;
a) a server processor configured to provide a server application comprising:
i) a software module configured to automatically analyze media consumed by the donor and determine one or more causes of interest for the donor based at least in part on the donor profile and online behavior of the donor;
ii) a software module configured to identify an authorized recipient associated with the cause; and
iii) a software module configured to transfer the funds from the pre-funded philanthropic giving account:
1) to the cause via the authorized recipient; or
2) return the donor funds to the pre-funded philanthropic giving account if an authorized recipient is not identified.
b) a data storage comprising:
i) donor data consisting the donor profile and online activity;
ii) cause data consisting different causes and their association with the media; and
iii) donation data consisting of causes the donor donates to.

44.-57. (canceled)
